(19) United States
(12) Patent Application Publication
(10) Pub. No.: US 2011/0192299 A1
(43) Pub. Date: Aug. 11, 2011

(54) HANDHELD STAMP WITH INTEGRATED ABRASIVE FEATURE

(76) Inventor: John Anthony, Downers Grove, IL (US)

(21) Appl. No.: 12/704,202

(22) Filed: Feb. 11, 2010

(51) Int. Cl. B41K 1/42

(52) U.S. Cl. 101/333

(57) ABSTRACT

A handheld stamper with an abrasive element. The handheld stamper includes an actuator mounted to a base, a stamping die coupled to one of the actuator or the base, and an abrasive element affixed to a surface of the handheld stamper. The handheld stamper is used to protect sensitive information, such as text, by using a combination of abrading the text with the abrasive element and imprinting an obscuring pattern over the text. To obscure the sensitive information, a medium, e.g. ink, forming the text is first abraded with the abrasive element to distort the medium. The abraded text is then stamped with the handheld stamp to sufficiently obscure the sensitive information.

### FIELD OF THE DISCLOSURE

The invention relates generally to handheld stamps, and more specifically to a handheld stamp having an integrated abrasive element for preparing ink before an obscuring pattern is imprinted thereon.

### BACKGROUND OF THE DISCLOSURE

Protection of personal and sensitive information from both identity theft and accidental dissemination to the public at large has become a significant concern in recent years. Complete destruction of documents containing sensitive information, such as by shredding, is the most common method of protecting sensitive information. However, shredding paper can have a negative environmental impact because it is often difficult, if not impossible, to recycle the shredded paper. When paper is shredded, the lengths of the individual paper fibers are cut, thereby reducing the future recycling potential of that fiber because longer fibers can be used to make a higher-grade paper that can be recycled more times than lower-grade papers. Additionally, paper mills that buy recycled must perform a quality sort on the material before processing, and it is virtually impossible to do a good quality sort on shredded paper because many contaminants can hide in the shred. Therefore, paper markets often times will not buy shredded paper. Finally, mixed paper from households, for example, will be cleaned by placing it over an automatic screen that shakes out non-fiber contaminants. However, often time fingers on the screens will grab the shredded paper, pulling the strips into the reject bin, which in turn is not recycled, but is rather disposed of in a landfill. See, for example, http://www.ecocycle.org/faq/shred.cfm.

In addition to the problems with recycling of shredded paper, certain types of documents that should be retained and not destroyed can also contain important information. For example, transactional documents for property, such as deeds and titles to property, can contain important information regarding the property and can be desirable to retain. However, it is often desirable to redact personal information, such as the addresses and contact information of buyers and sellers, also contained within the transactional document when such information is no longer relevant or necessary. Documents are often selectively redacted by applying heavy inks or corrective tape to the paper to blot out or cover sensitive information without obscuring the information to be retained. However, such methods are labor intensive and may damage the underlying paper. Any damage to the underlying paper may compromise the integrity of the document as a whole causing the document to deteriorate over time and destroy the retained information with the redacted information.

Another method for redacting sensitive information is a stamp for imprinting an obscuring pattern over the sensitive information. For example, U.S. Patent Application Publication No. 2009/0183645 to Yonetsu et al. illustrates a handheld stamp having a die for imprinting a pattern of shapes and characters over text to obscure the underlying text. The reference is herein incorporated by reference in its entirety. The distorting pattern obscures the characters of the underlying text with a dense pattern of characters and shapes that break up the shape and lines defining the underlying text. An imprinted distorting pattern requires less ink then blotting out the text with a heavy ink because the underlying text is only distorted by the pattern rather than completely covered with ink. As a result, an imprinted distorting pattern is less likely to damage the underlying paper than conventional blotting methods because less ink is required.

However, differences in the characteristics of the ink used for the distorting pattern and the ink used to print or write the underlying text may prevent an imprinted distorting pattern from completely obscuring the underlying text. Specifically, the ink used for printing or writing is typically glossier in appearance than the ink used in stamps for imprinting. The glossiness of the underlying printed or written text causes the underlying text to standout against the more matte ink of the obscuring pattern. While the obscuring pattern may make the underlying text more difficult to read, the glossiness of the ink prevents the text from being completely illegible.

Similarly, certain printing techniques and papers create raised text where the dried ink of the text is in relief against the plane of the paper. In contrast, the ink used in stamps typically imprints images nearly flush with the plane of the paper or the ink is fully absorbed into the paper. The difference in the height of the text above the plane of the paper causes the printed text to stand out against the obscuring pattern preventing the obscuring pattern from making the underlying text completely illegible. As such, imprinting distorting patterns alone is often insufficient to completely obscure sensitive information.

### SUMMARY OF THE DISCLOSURE

Embodiments of the invention provide a handheld stamper with an abrasive element. The handheld stamper is used to protect sensitive information or indicia by imprinting an obscuring pattern over the indicia after abrading the indicia. The abrasive element is adapted to distort the underlying indicia by removing the glossy exterior of the dried ink or other medium of the underlying text without damaging the underlying paper, for example, or by removing a majority or all of the medium such that the indicia is partially or completely unrecognizable. The abrasive element can also be adapted to smooth any raised text such that the text is no longer in relief against the paper. By abrading or otherwise distorting the ink or other medium of the sensitive text or other indicia before imprinting an obscuring pattern over the text, the effectiveness of the obscuring pattern in rendering the underlying text or indicia illegible is improved.

In a representative embodiment, the handheld stamper can comprise an actuator mounted to a base, a stamping die coupled to one of the actuator or the base, and an abrasive element affixed to a surface of the handheld stamper. The abrasive element can be either removably or permanently affixed to an exterior of the actuator, the base, dust cover (if present), or the stamping die, for example.

To obscure indicia, such as, for example, sensitive information on a document, a medium, e.g. ink, forming the indicia is first abraded with the abrasive element to distort the indicia, such as, for example, by reducing a gloss value of the medium. The abraded indicia is then stamped with the handheld stamp to sufficiently obscure the indicia. In alternative embodiments, the indicia is abraded such that the indicia is sufficiently obscured and a subsequent stamping step is not required. The handheld stamper of the present disclosures allows for sufficient obscurity of sensitive information while maintaining the integrity, such as the recyclability, of the underlying paper or other substrate containing the sensitive information.

The above summary of the invention is not intended to describe each illustrated embodiment or every implementation of the present invention. The Figures and the Detailed Description that follow more particularly exemplify these embodiments.

### BRIEF DESCRIPTION THE FIGURES

The invention may be more completely understood in consideration of the following detailed description of various embodiments of the invention in connection with the accompanying drawings, in which:

FIG. 1 is a front view of a handheld stamper with abrasive element according to an embodiment of the present invention;

FIG. 2 is a side view of the handheld stamper with abrasive element of FIG. 1;

FIG. 3 is a back view of the handheld stamper with abrasive element of FIG. 1;

FIG. 4 is a perspective view of the bottom of the handheld stamper of FIG. 1;

FIG. 5 is an obscuring pattern produced by the handheld stamper of FIG. 1;

FIG. 6 is perspective view of a handheld stamper with dust cover and abrasive element according to an alternative embodiment of the present invention;

FIG. 7 is a perspective view of a stamping die and cover of the handheld stamper of FIG. 6.

FIG. 8A is a top view of a handheld stamper with abrasive element according to another alternative embodiment of the present invention;

FIG. 8B is a front view of the handheld stamper with abrasive element of FIG. 8A;

FIG. 8C is a side view of the handheld stamper with abrasive element of FIG. 8A;

FIG. 9A is a top view of a handheld stamper with abrasive element according to another alternative embodiment of the present invention;

FIG. 9B is a front view of the handheld stamper with abrasive element of FIG. 9A;

FIG. 9C is a side view of the handheld stamper with abrasive element of FIG. 9A;

FIG. 10A is a top view of a handheld stamper with abrasive element according to another alternative embodiment of the present invention;

FIG. 10B is a front view of the handheld stamper with abrasive element of FIG. 10A;

FIG. 10C is a side view of the handheld stamper with abrasive element of FIG. 10A;

FIG. 11 A is a front view of a handheld stamper with dust cover and abrasive element according to another alternative embodiment of the present invention;

FIG. 11B is a front exploded view of the handheld stamper with dust cover and abrasive element of FIG. 11A;

FIG. 11C is a top view of the handheld stamper with dust cover and abrasive element of FIG. 11A;

FIG. 11 D is a side view of the handheld stamper with dust cover and abrasive element of FIG. 11A;

FIG. 12A is a front view of a handheld stamper with dust cover and abrasive element according to another alternative embodiment of the present invention;

FIG. 12B is a top view of the handheld stamper with dust cover and abrasive element of FIG. 12A;

FIG. 12C is a side view of the handheld stamper with dust cover and abrasive element of FIG. 12A;

FIG. 13A is a front view of a handheld stamper with dust cover and abrasive element according to another alternative embodiment of the present invention;

FIG. 13B is a top view of the handheld stamper with dust cover and abrasive element of FIG. 13A; and

FIG. 13C is a side view of the handheld stamper with dust cover and abrasive element of FIG. 13A.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

According to embodiments of the present invention, handheld stampers, self-inking or otherwise, generally comprise a base, an actuator mounted on the base and movable with respect to the base, a stamping die for forming an obscuring pattern over indicia on a working surface, and an abrasive element affixed to a surface of the stamper, the abrasive element having an abrading surface for distorting the indicia, such as by reducing a gloss value or flattening raised surface, before stamping with the obscuring pattern. Upon movement of the actuator, the stamping die is shifted from a resting position to a printing position.

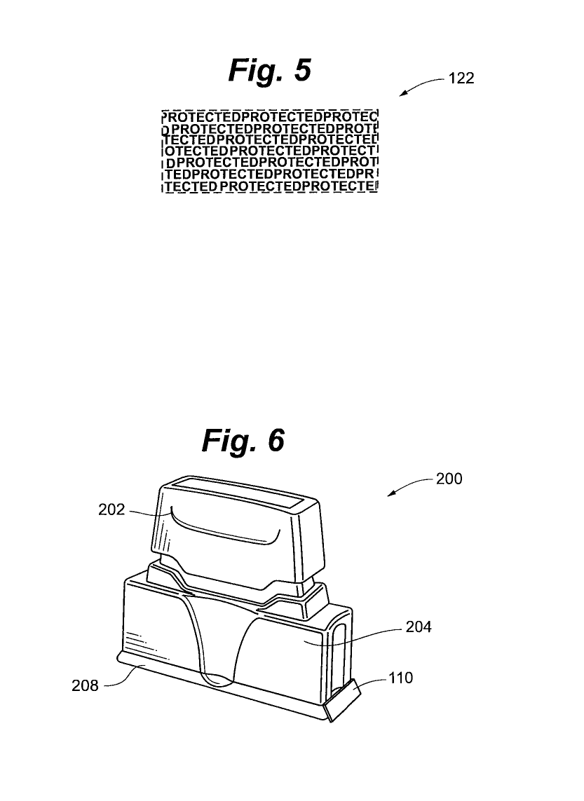

In use, it is desired to obscure indicia, such as personal information or text, of a working surface, such as a paper or other document. Before stamping the indicia, the handheld stamp is placed proximate the working surface such that the abrading surface of the abrasive element is in contact with the indicia to be obscured. The ink or other medium forming the indicia is abraded until the indicia is distorted or destroyed. The indicia can be completely unreadable or only partially destroyed. In one embodiment, the indicia is distorted by reducing a gloss of the indicia. The indicia is then stamped with an obscuring pattern 122, as illustrated in FIG. 5. The abraded and stamped indicia is significantly more obscured than the indicia without abrading.

In an alternative embodiment, the indicia is completely distorted or obliterated by abrading alone such that a subsequent stamping step is not required, and the indicia is unreadable or unrecognizable, such that the sensitive information is sufficiently protected.

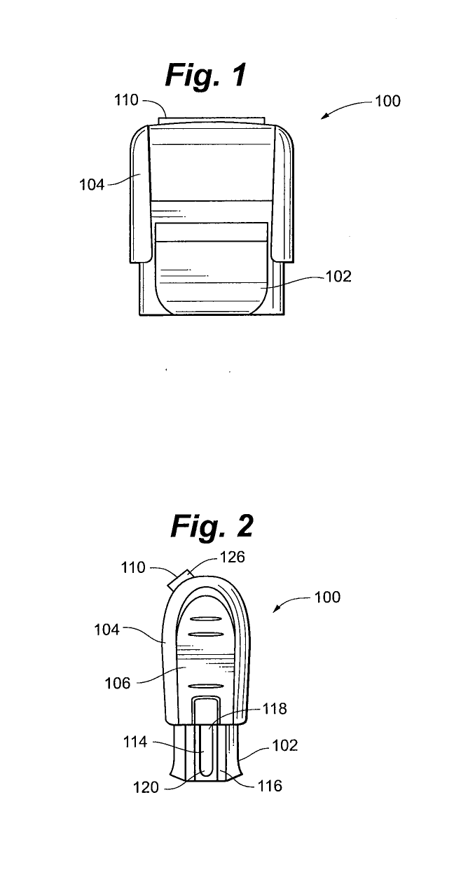

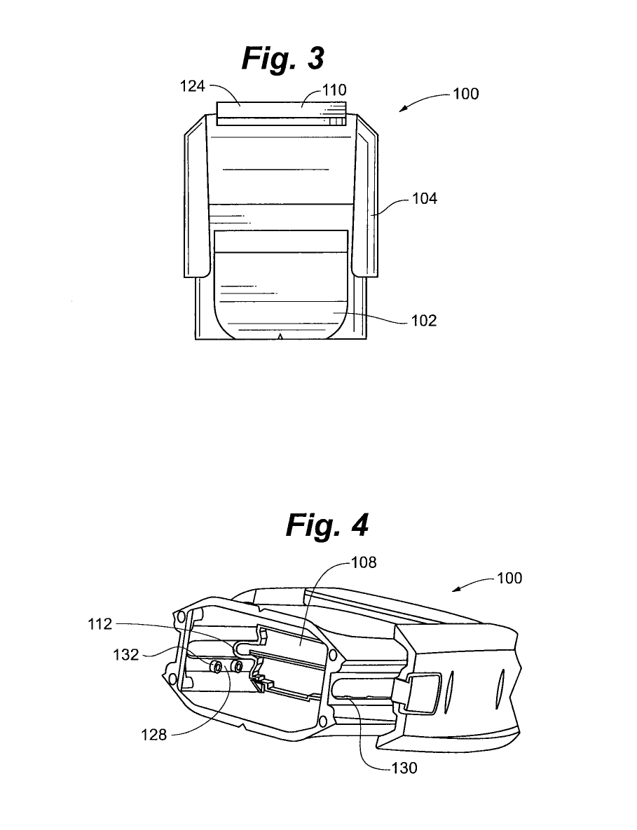

In a representative embodiment illustrated in FIGS. 1-4, a handheld stamper 100 for imprinting obscuring patterns generally can comprise a base 102, an actuator 104 mounted on base 102, a stamping die 108, and an abrasive element 110. Actuator 104 is spring mounted on base 102, such as by a compression spring, and slides up and down over base 102 in order to operate stamper 100.

Stamping die 108 can be coupled to actuator 104 by a shaft or pintel 112. As illustrated in FIGS. 1-4, stamping die 108 is mounted to or integral with shaft 112. Base 102 includes a groove 114 on each side wall 116 in which a post at each end of shaft 112 extends through, connecting to sidewalls 106 of actuator 104. Shaft 112 with stamping die 108 is slidable relative to base 102 for allowing stamping die 108 to reversibly move into and out of an opening at the bottom of base 102 to contact a working surface.

Stamping die 108 can comprise a plurality of densely arranged characters, figures or pictures, and/or straight or curved lines for producing an obscuring pattern. Referring to FIG. 4, an obscuring pattern 122 is produced over the desired area of a working surface when stamped.

Abrasive element 110 comprises an abrasive surface 124. Abrasive element 110 can be positioned on any surface of handheld stamper 100 including, but not limited to base 102, actuator 104. In one embodiment of the invention illustrated in FIGS. 1-3, abrasive element 110 is affixed to actuator 104 by an adhesive 126. In other embodiments, abrasive element 110 is affixed to one or more surfaces of base 102, and/or to stamp assembly 106.

Abrasive element 110 can be affixed to any surface of handheld stamper 100 by any of a variety of attachment mechanisms such as, for example, adhesive, epoxy, tacks, staples, a hook and loop system, or any other method of permanently or removably affixing abrasive element 110 to handheld stamper 100. In one embodiment, abrasive element is removably affixed to handheld stamper 100 to allow replacement of abrasive element 110 with a fresh abrasive surface.

Abrasive surface 124 of abrasive element 110 has sufficient abrasive qualities, such as coarseness, to distort the indicia to be reduce a gloss value from ink or smooth raised text. Abrasive element should also be sufficiently fine to prevent or reduce damage to the underlying paper or other working surface. In one embodiment of the invention, as illustrated in the Figures, abrasive surface 124 can comprise sandpaper having a mesh grade from about P150 to about P1200, which is the equivalent of an average particle size in the range of about 15 to about 80 microns. The abrasive mineral can comprise aluminum oxide (alumina), silicon carbide, ceramics, or any of a variety of abrasive minerals or combinations thereof.

Abrasive element 110 can alternatively comprise steel wool and synthetic steel wool abrasives, coarse rubber or plastic pads, or any other form of abrasive capable of reducing the gloss value from the ink and/or smoothing raised text without damaging the underlying paper.

In other embodiments, abrasive element 110 can further comprise a cushioning layer 126 disposed between a surface of handheld stamper 100 and abrasive surface 124. Cushioning layer 126 can act to reduce the amount of force applied to the underlying paper or working surface through abrasive element 110 thereby minimizing the risk of damaging the paper or working surface. Cushioning layer 126 can comprise for example, foam, rubber, felt or other compressible or uncompressible materials capable of minimizing or reducing the force applied to the underlying working surface or paper by abrasive element 110.

As illustrated in FIGS. 1-4, shaft 112 resides at a top 118 of groove 114 such that stamping die 108 rests on an inking pad (not shown) housed within actuator 104. In operation, force is applied to the top of actuator 104, thereby depressing the compression spring. Shaft 112 translates along groove 114, moving stamping die 108 of stamp assembly 106 away from the inking pad and towards an open end of the base 102. A lateral pathway 128 in groove 114 causes shaft 112 and therefore stamping die 108 to rotate such that inked stamping die 108 faces outwardly towards a working surface. Lateral pathway 128 can comprise, as illustrated in FIG. 4, a rim 130 with protrusions 132 that abut shaft 112 as it slides downward, forcing shaft 112 to rotate. Upon complete compression, i.e. when shaft 112 has traveled to bottom 120 of groove 112, stamping die 108 comes into contact with the working surface, stamping an obscuring pattern on the desired area of the working surface. As the force is removed from actuator 104, shaft 112 travels back to top 118 of groove 114, thereby retracting stamping die 108 into actuator 104 into the initial resting position.

In an alternative embodiment illustrated in FIGS. 8A-8C, a handheld stamper 300 comprises a handheld stamper similar in structure and function to the embodiment illustrated in FIGS. 1-4 and includes a base 302 and actuator 304 slidably disposed on base 302. In this embodiment, actuator 304 comprises a flattened top surface 306 with abrasive element 110 affixed thereto. As discussed previously, abrasive element can be affixed to top surface 306 by any of a variety of attaching mechanisms, such as, for example, an adhesive surface, or alternatively, by a frame element in which an aperture is defined in top surface 306, and abrasive element 110 is received therein either by attachment from the interior or exterior of actuator 304.

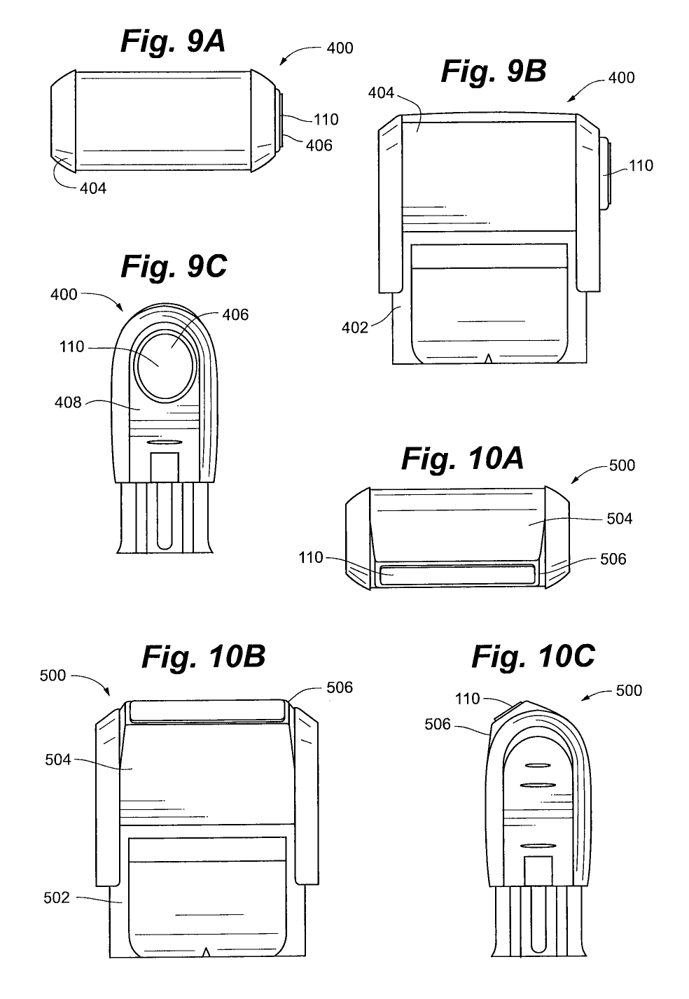

In another alternative embodiment illustrated in FIGS. 9A-9C, a handheld stamper 400 is similar in structure and function to the embodiment illustrated in FIGS. 1-4 and includes a base 402 and actuator 404 slidably disposed on base 402. In this embodiment, a snap-on molded piece 406 with abrasive element 110 affixed thereto, can be coupled to a receiving portion located on any surface of actuator 404. For example, actuator 404 can be adapted to receive snap-on piece 406 on side surface 408 of actuator 404. Abrasive element 110 can be affixed to piece 406 by the attachment mechanisms discussed above.

In yet another alternative embodiment illustrated in FIGS. 10A-10C, a handheld stamper 500 is similar in structure and function to the embodiment illustrated in FIGS. 1-4 and includes a base 502 and actuator 504 slidably disposed on base 502. In this embodiment, actuator 504 comprises a flattened angled surface 506 with abrasive element 110 affixed thereto. Abrasive element 110 can be affixed to angled surface 506 by the attachment mechanisms discussed above.

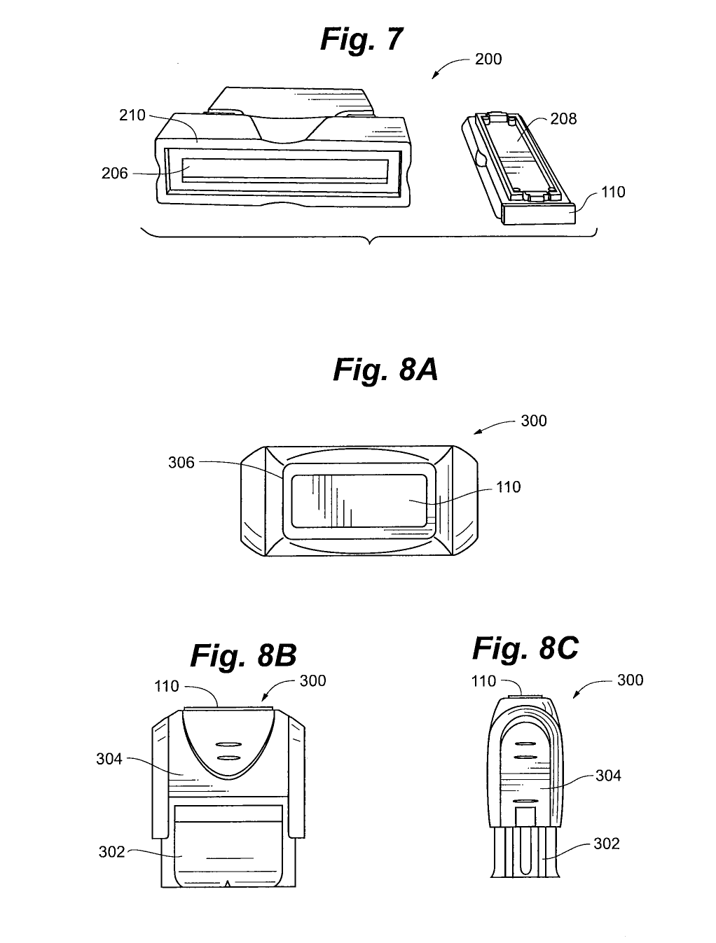

In an alternative embodiment illustrated in FIGS. 6 and 7, a handheld stamper 200 includes an actuator 202, a base member 204 comprising a sleeve, a stamping die 206, a cover 208, and abrasive element 110 having abrasive surface 124. In this embodiment, actuator 202 slides within base member 204 when force is applied to actuator 202. Actuator 202 slides within base member 204 from a resting position wherein stamping die 206 is housed within base member 204, and an operating position wherein stamping die 206 comes into contact with a working surface.

Stamping die 206 can be immovably affixed to actuator 202 such that the stamping face of stamping die 206 is permanently facing outwardly from a bottom opening 212 of base member 204. Stamping die 206 is inked upon compression when an inked pad sandwiched between stamping die 206 and actuator 202 is also compressed such that ink is forced through openings in stamping die 206. Cover 208 can be removably attached to bottom opening 212 of base member 204 to protect stamping die 206 and to prevent or reduce the inked pad from drying out.

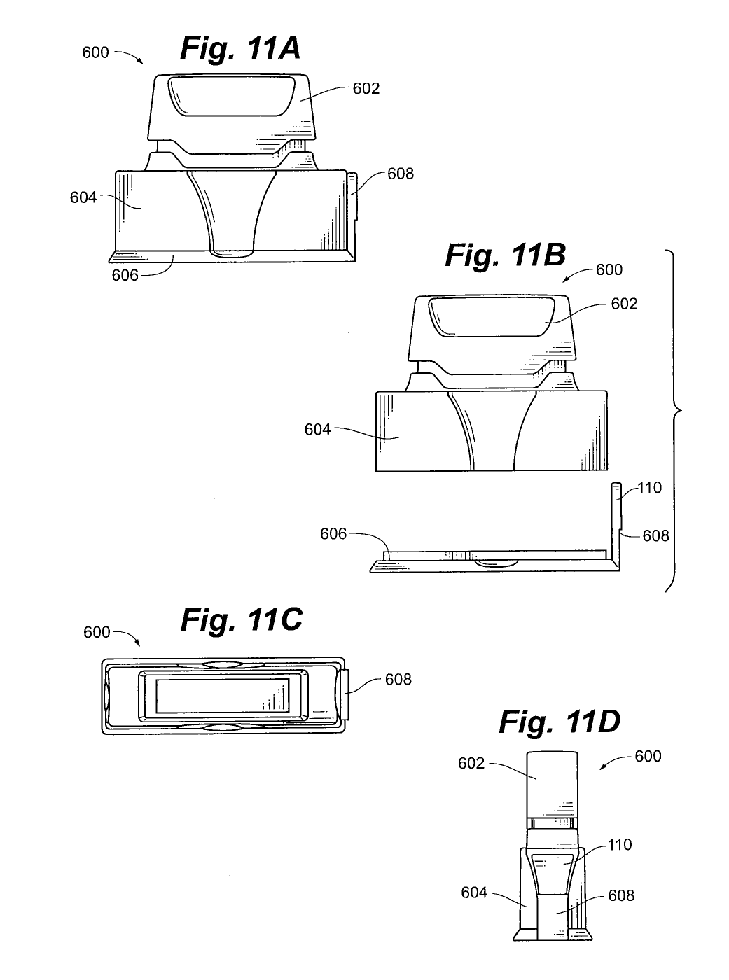

In an alternative embodiment illustrated in FIGS. 11A-11D, a handheld stamper 600 comprises a handheld stamper similar in structure and function to the embodiment illustrated in FIGS. 6 and 7, and includes an actuator 602, a base member 604 comprising a sleeve, and a dust cover 606. Dust cover 606 includes a flange 608 extending upwardly from at least one of a side edge, a front edge, and a back edge of cover 606. Abrasive element 110 is affixed to flange 608 by any of the variety of attaching mechanisms discussed supra. Abrasive element 110 can be used when dust cover 606 is coupled to base member 604, or separate from base member 604.

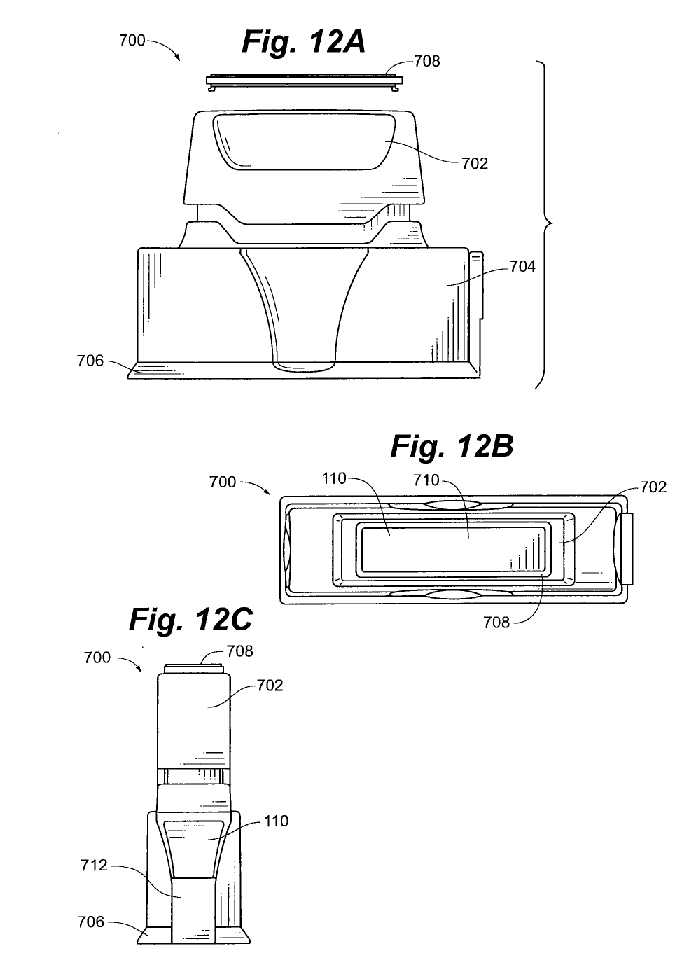

In addition to or in alternative to the embodiment illustrated in FIGS. 11A-11D, an embodiment illustrated in FIGS. 12A-12C include a handheld stamper 700 comprising an actuator 702, a base member 704 comprising a sleeve, and a dust cover 706. Actuator 702 includes a snap-on piece 708 removably or permanently affixed upon snapping to a surface of actuator 702, such as a top surface, as shown. Piece 708 includes abrasive element 110 affixed thereon by any of the attachment mechanisms described supra. In one particular embodiment as shown, abrasive element 110 includes a cutout area 710 or stencil representing text or any other of a variety of indicia, such as, for example, a product name. Handheld stamper 700 as shown can optionally include a second abrasive element 110 located on flange 712 extending from dust cover 706.

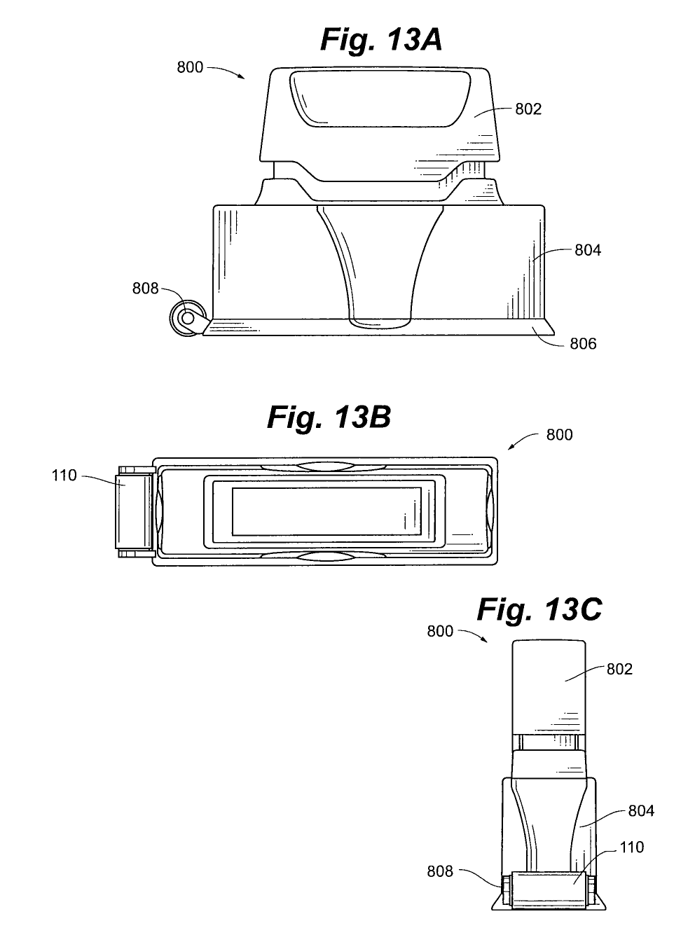

In an yet another alternative embodiment illustrated in FIGS. 13A-13C, a handheld stamper 800 comprises a handheld stamper similar in structure and function to the embodiment illustrated in FIGS. 6 and 7, and includes an actuator 802, a base member 804 comprising a sleeve, and a dust cover 806. Dust cover 606 includes an extension 808 adapted for mounting an abrasive element 110 in the form of an abrasive roller thereto. Extension 808 extends upwardly at an angle from at least one of a side edge, a front edge, and a back edge of cover 806. Abrasive element 110 is attached to a rotable post of extension 808 such that abrasive element rolls freely on extension 808. Abrasive element 110 can be used when dust cover 806 is coupled to base member 804, or separate from base member 804.

Any number of additional embodiments can be contemplated that include combinations of one or more of the abrasive element systems as discussed above, and are not limited to the representative embodiments illustrated in the figures.

As discussed above, the embodiments described are for exemplary purposes only and any of a variety of handheld, self-inking or non-self-inking stamps are contemplated. Examples include, but are not limited to, U.S. Pat. No. 4,289,070 entitled “Rubber Stamp” to MacGregor, U.S. Pat. No. 7,487,723 entitled “Hand held two-ended ink stamper” to Moody, U.S. Pat. No. 7,086,331 entitled “Hand-held ink stamper with spare ink supply” to Moody, and U.S. Patent Application Publication No. 2009/0183645 entitled “Stamping Device” to Yonetsu et al., all of which are incorporated herein by reference in their entireties.

Although specific examples have been illustrated and described herein, it will be appreciated by those of ordinary skill in the art that any arrangement calculated to achieve the same purpose could be substituted for the specific example shown. This application is intended to cover adaptations or variations of the present subject matter. Therefore, it is intended that the invention be defined by the attached claims and their legal equivalents.

What is claimed is:

1. A handheld stamper for obscuring indicia on a working surface, the handheld stamper comprising:
a base;
an actuator slidably mounted to the base;
a stamping die operably coupled to one of either the base or the actuator, the stamping die being shiftable between a resting position and a printing position upon movement of the actuator, wherein the stamping die is adapted to print an obscuring pattern over the indicia when in the printing position; and
an abrasive element affixed to the base or the actuator, the abrasive element presenting an abrading surface adapted to abrade a medium forming the indicia thereby at least partially distorting the indicia before the obscuring pattern is applied to the indicia.

2. The handheld stamper of claim 1, further comprising:
a shaft affixed to the actuator, the stamping die being mounted to or integrated with the shaft,
wherein the base includes two sidewalls, each sidewall having structure defining an elongated slot,
wherein a first end of the shaft is mounted within the slot of one sidewall, and a second opposing end of the shaft is mounted within the slot of the other sidewall, such that the shaft is translatable along a length of the slot.

3. The handheld stamper of claim 2, wherein the stamping die is in the resting position when the shaft is positioned in a top end of the slot on each sidewall, and wherein the stamping die is in the printing position when the shaft is positioned in the bottom end of the slot on each sidewall such that the stamping die is in contact with the working surface.

4. The handheld stamper of claim 1, wherein the actuator is mounted to the base by a compression spring, and the stamping die shifts between the resting position and the printing position when force is applied to the actuator, such that the compression spring is under load.

5. The handheld stamper of claim 1, wherein the abrasive element comprises a coated abrasive having a particle size in the range of from about 15 μm to about 80 μm.

6. The handheld stamper of claim 1, wherein the abrasive element is affixed to the base or the actuator by a fastening mechanism selected from the group comprising adhesive, hook and loop systems, snaps, and combinations thereof.

7. The handheld stamper of claim 6, wherein the abrasive element is removably affixed to either the base or the actuator using a hook and loop system, wherein the base or the actuator includes one of either a hook or loop fastener, and a non-abrading surface of the abrasive element includes the other of the hook or loop fastener, such that the abrasive element can be removed to be replaced a new abrasive element.

8. The handheld stamper of claim 1, wherein the abrading surface is adapted to distort the medium by reducing a gloss value of the medium forming the indicia.

9. The handheld stamper of claim 1, further comprising:
a cushioning layer positioned between the abrasive element and a surface of the base or the actuator to which it is affixed.

10. The handheld stamper of claim 1, wherein the base includes a dust cover removably coupled to a bottom opening of the base, wherein the dust cover is adapted to cover the bottom opening of the base thereby preventing the stamping die from shifting into the printing position when the dust cover is coupled to the base, and wherein the abrasive element is affixed to a surface of the dust cover.

11. A method of obscuring indicia on a working surface, the method comprising:
providing a handheld stamper, the handheld stamper including
a base,
an actuator slidably mounted to the base,
a stamping die operably coupled to one of the base or the actuator, the stamping die presenting a stamping face defining an obscuring pattern, and
an abrasive element affixed to the base or the actuator, the abrasive element presenting an abrading surface;
abrading a medium forming the indicia thereby distorting the indicia; and
stamping the distorted indicia with the obscuring pattern by sliding the actuator with respect to the base such that the stamping face comes into contact with the indicia, thereby obscuring the indicia.

12. The method of claim 11, wherein abrading the indicia comprises:
contacting the abrading surface of the abrasive element with the medium forming the indicia; and
rubbing the abrading surface over the medium thereby reducing the gloss value.

13. The method of claim 11, wherein stamping the indicia comprises:
applying a downward force to the actuator such that the actuator slides on the base towards the working surface, wherein the stamping die shifts from an initial resting position to a printing position when the stamping face comes into contact with the working surface; and
removing the downward force such that the actuator slides on the base towards the working surface such that the stamping die shifts from the printing position to the initial resting position.
